(19) United States
(12) Patent Application Publication
(10) Pub. No.: US 2005/0091180 A1
(43) Pub. Date: Apr. 28, 2005

(54) Method and apparatus for refreshing materialized views

(76) Inventors: Nitzan Peleg, Haifa (IL); Amir Bar-or, Haifa (IL); Yuval Sherman, Sunnyvale, CA (US); Edward Bortnikov, Haifa (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/690,762

(22) Filed: Oct. 22, 2003

(51) Int. Cl. G06F 7/00

(52) U.S. Cl. 707/1

(57) ABSTRACT

The disclosed embodiments relate to a system and method for refreshing a materialized view that is at least in part derived from a table. The system may be adapted to provide availability of the table and the materialized view while the materialized view is being refreshed. The system may include a refresh log that contains a plurality of entries, each of the plurality of entries corresponding to a change in the table, each of the plurality of entries comprising an epoch identifier. The system may also include a refresh manager that performs a refresh operation on the materialized view in multiple steps by (a) successively reading a first subset of the plurality of entries indicated by a specific epoch identifier from the refresh log, (b) identifying a second subset of the plurality of entries from within the first subset of the plurality of entries, the second subset of the plurality of entries falling within a primary key value boundary and (c) applying the second subset of the plurality of entries to the materialized view.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Modem computer databases may store immense amounts of data. This data is typically stored in one or more tables that comprise the database. If a database contains large amounts of data, it may take a relatively long time to perform a query to retrieve data that is of interest to a user. The time required for a database to respond to a query may have an adverse impact on the performance of the database as a whole. If the database is subject to a large number of complex queries, the response time for each query may be seriously lengthened. A query may identify a subset of elements of a table. The subset may be referred to as a “view.” If a view requires information from several tables or is frequently requested by users, the view may be created as a “materialized view” to improve the performance of the database. When a view is materialized, it may actually be stored as a separate table within the database. Queries may then be run against the materialized view without incurring processing time penalties for reassembling the information contained in the materialized view each time a query that may be satisfied by the materialized view is performed.

In order to make sure that the integrity of data provided by a database is maintained, the data stored in a materialized view may need to be updated when the underlying data in the base tables that affect the materialized view is changed. When changes to underlying base tables occur, the database management system (“DBMS”) may create and/or update a log showing the changes. Periodically, the DBMS may use the information contained in the log to update or refresh a materialized view.

In a complex database environment, either immediate refreshing or deferred refreshing may be employed. Immediate refreshing refers to a policy in which materialized views are updated after every change to an underlying base table. In many cases, immediate refreshing is not practical because it requires a lot of system overhead. For a deferred refresh policy, updates are collected in a log and applied periodically. The time that it takes to update a materialized view may be significant. During the time that a materialized view is being updated, the materialized view may not be available to provide data in response to queries. A method and apparatus that improves the availability of materialized views in databases that employ a deferred refresh policy and may provide other advantages is desirable.

### BRIEF DESCRIPTION OF THE DRAWINGS

Advantages of one or more disclosed embodiments may become apparent upon reading the following detailed description and upon reference to the drawings in which:

FIG. 1 is a block diagram illustrating a computer network in accordance with embodiments of the present invention;

FIG. 2 is a block diagram illustrating a materialized view update log that may be implemented in embodiments of the present invention.

FIG. 3 is a block diagram showing a system that may perform logging and conflict resolution in accordance with embodiments of the present invention;

FIG. 4 is a schematic diagram illustrating conflicts between a single-row and a range in a database environment in accordance with embodiments of the present invention;

FIG. 5 is a schematic diagram showing the effects of conflicts between deltas in a database refresh operation in accordance with embodiments of the present invention;

FIG. 6 is a schematic diagram illustrating the concept of catch-up in a database environment in accordance with embodiments of the present invention;

FIG. 7 is a finite state diagram of a highly available materialized view in accordance with embodiments of the present invention; and

FIG. 8 is a schematic diagram that illustrates a nested catch-up scenario in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

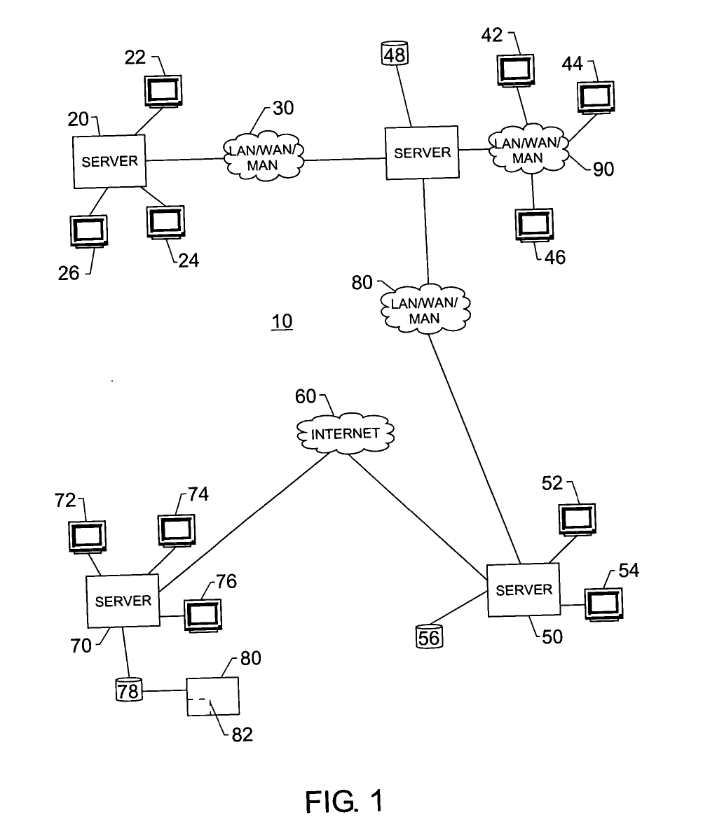

Turning now to the drawings and referring initially to FIG. 1, a block diagram of a computer network architecture is illustrated and designated using a reference numeral 10. A server 20 may be connected to a plurality of client computers 22, 24 and 26. The server 20 may be connected to as many as “n” different client computers. Each client computer in the network 10 may be a functional client computer. The magnitude of “n” may be a function of the computing power or capacity of the server 20. The computing power or capacity of the server 20 may be a function of many design factors such as the number and speed of processors and/or the size of the system memory, for example.

The server 20 may be connected via a network infrastructure 30, which may include any combination of hubs, switches, routers, and the like. While the network infrastructure 30 is illustrated as being either a local area network (“LAN”), storage area network (“SAN”) a wide area network (“WAN”) or a metropolitan area network (“MAN”), those skilled in the art will appreciate that the network infrastructure 30 may assume other forms or may even provide network connectivity through the Internet. As described below, the network 10 may include other servers, which may be dispersed geographically with respect to each other to support client computers in other locations.

The network infrastructure 30 may connect the server 20 to server 40, which may be representative of any other server in the network environment of server 20. The server 40 may be connected to a plurality of client computers 42, 44, and 46. As illustrated in FIG. 1, a network infrastructure 90, which may include a LAN, a WAN, a MAN or other network configuration, may be used to connect the client computers 42, 44 and 46 to the server 40. A storage device 48 such as a hard drive, storage area network (“SAN”), RAID array or the like may be attached to the server 40. The storage device 48 may be used to store a database or portion of a database for use by other network resources. Portions or partitions of a single database may be stored on various different storage devices within the network 10.

The server 40 may be adapted to create log files for updating materialized views that may be stored on the storage device 48. For example, the server 40 may be adapted to identify Insert/Update or Delete operations made to base tables that affect the materialized view and create a log entry with a timestamp indicating when the operation to the base table occurred.

The server 40 may additionally be connected to server 50, which may be connected to client computers 52 and 54. A network infrastructure 80, which may include a LAN, a WAN, a MAN or other network configuration, which may be used to connect the client computers 52, 54 to the server 50. The number of client computers connected to the servers 40 and 50 may depend on the capacity of the servers 40 and 50 to process information. A storage device 56 such as a hard drive, storage area network (“SAN”), RAID array or the like may be attached to the server 50. The storage device 56 may be used to store a database or portion of a database for use by other network resources.

The server 50 may be adapted to create log files for updating materialized views that may be stored on the storage device 56. For example, the server 50 may be adapted to identify Insert/Update or Delete operations made to base tables that affect the materialized view and create a log entry with a timestamp indicating when the operation to the base table occurred.

The server 50 may additionally be connected to the Internet 60, which may be connected to a server 70. The server 70 may be connected to a plurality of client computers 72, 74 and 76. The server 70 may be connected to as many client computers as its computing power may allow. A storage device 78 such as a hard drive, storage area network (“SAN”), RAID array or the like may be attached to the server 40. The storage device 78 may be used to store a database 80 or portion of a database for use by other network resources. The database 80 may comprise a materialized view 82 (shown in dashed lines). Those of ordinary skill in the art will appreciate that other storage devices in the network 10 may store databases, which may include materialized views.

The server 70 may be adapted to create log files for updating materialized views that may be stored on the storage device 78 such as the materialized view 82. For example, the server 70 may be adapted to identify Insert/Update or Delete operations made to base tables that affect the materialized view and create a log entry with a timestamp indicating when the operation to the base table occurred.

Those of ordinary skill in the art will appreciate that the servers 20, 40, 50, and 70 may not be centrally located. Accordingly, the storage devices 48, 56 and 78 may also be at different locations. A network architecture, such as the network architecture 10, may typically result in a wide geographic distribution of computing and database resources.

The use of databases in a networked computing environment is an important tool in a modern business environment. A database may be described as a collection of related records or tuples of information or data. A relational database is a popular type of database. In a relational database, a structured set of tables or relations is defined. The tables may be populated with rows and columns of data. The entire collection of tables makes up a relational database.

A database may be accessed through an application program, which may be referred to as a database management system or “DBMS.” The DBMS typically performs database management functions. The DBMS may additionally allow users to add new data to the database or access data that is already stored in the database. An access to the database is typically referred to as a “query.” A query may be performed across an entire relational database and may request data from one or more tables within the database. The organization of the data requested by a query may be called a “view.” Views may not exist independently within the database, but may only exist as the output from a query.

In a networked computing environment, the information stored in a database may not all be in a centralized location. Portions of data in a single relational database may be stored on different servers on different network segments, or even in different cities or countries. To make processing the information faster, a relational database may be partitioned among a number of servers to allow parallel processing of queries. The use of materialized views may also make the processing of queries more efficient.

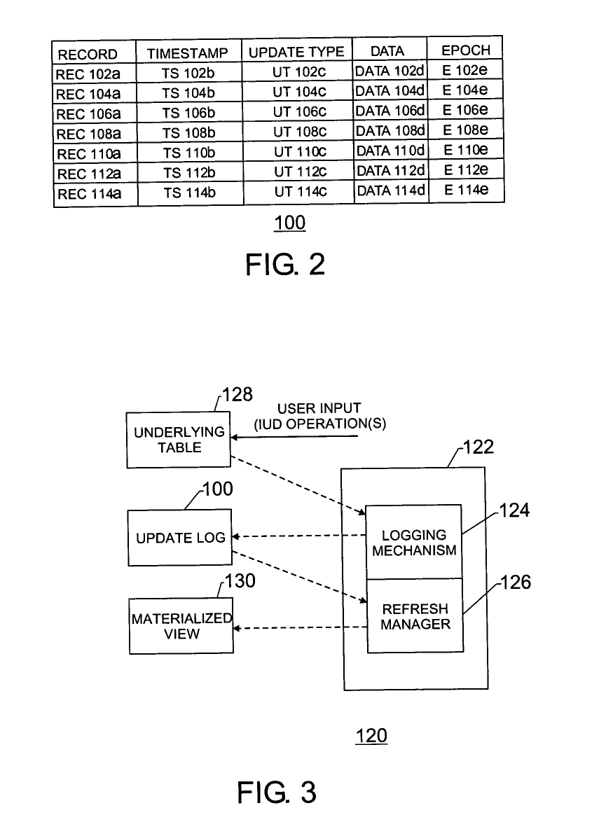

FIG. 2 is a block diagram illustrating a materialized view update log that may be implemented in embodiments of the present invention. When a materialized view is created, it may be designated to be refreshed according to one of two incremental refresh policies. Those policies may be referred to as a deferred refresh policy and an immediate refresh policy.

Database tables that have one or more materialized views defined on them and that employ a deferred refresh policy may automatically maintain a log similar to the log shown in FIG. 2. The refresh operations, including maintaining and updating the refresh log, may be performed by a part of the DBMS that may be referred to as a refresh manager. In FIG. 2, a partial excerpt of a refresh log is generally identified by the reference numeral 100. Because the refresh log contains information about Insert, Update and Delete operations, the refresh log may be referred to as an IUD or an update log. The information shown in the log excerpt 100 is an example of the information that may be included in such a log. Those of ordinary skill in the art will appreciate that various combinations of data, including additional data or subsets of the data shown may exist in actual databases.

Each base table in a database may have its own IUD log. That log may serve all the deferred materialized views based on the base table. Accordingly, the IUD log for a particular table may be referred to as a T-log.

Each row of the IUD log 100 may constitute a separate record, which contains information about a change to the underlying table. The IUD log 100 may comprise a record column which may include an indication of the records that have been modified in a particular base table that contains data used in a particular materialized view. The record field identifies the base table row that was altered. In FIG. 2, the record column is populated with record identifiers 102a-114a, which may be primary keys. A primary key is an attribute or combination of attributes that, by itself, guarantees the uniqueness of each table row. Those of ordinary skill in the art will appreciate that the IUD log 100 may contain multiple entries to the same base table row if that row has been altered more than once. A timestamp column contains timestamps indicative of the time at which the corresponding record in the base table was inserted, updated or deleted. The timestamps are identified by the reference numerals TS 102b-TS 114b in FIG. 2. As set forth above, the timestamps may not be correctly synchronized because they may have been generated by different nodes in a networked computing environment. In such a system, various components of a base table may be distributed in partitions that are located on a number of different computing nodes, as illustrated in FIG. 1.

The IUD log 100 may include an update type column that may contain data indicative of the type of update that was performed on the base table. The update type information may be useful in determining how to update associated materialized views when a refresh operation is performed. The update type column in FIG. 2 is populated with data elements identified as UT 102c-UT 114c.

The refresh log or IUD log 100 may include a column indicative of the data that was added or modified in the base table row associated with the corresponding record identifier. These data elements are identified as data 102d-data 114d in FIG. 2. If the update type in the update type column indicates that the record was deleted from the base table, the data element for that record may be populated with a bogus value.

Each row or record of the IUD log 100 may also include an epoch number. In FIG. 2, the epoch numbers for the rows shown are referred to as E 102e-E 114e in FIG. 2. The epoch number may be used to identify a group of rows or records that have been added to the IUD log 100 since a previous refresh operation was performed. A potential problem with refreshing materialized views may relate to the synchronization between the IUD log 100 and the actual performance of the refresh operation. The use of the epoch number may help to address this problem by avoiding inclusion of records corresponding to transactions that occurred outside a refresh time range or omitting records corresponding to transactions that actually occurred within a particular refresh time range.

Each base table may have a single epoch number that may be stored as part of the metadata information of the database. Metadata is data stored with the database that relates to the organizational structure and operation of the database. The epoch number may also be visible as part of the runtime information for the associated table. That information may reside in system memory during execution.

When log entries are created in the IUD log 100 (FIG. 2), the current epoch number may be read from the runtime information of the table and written to the log record. When completed, each entry in the refresh log or IUD log 100 may comprise a record that includes a record identifier (e.g. Record 102a), a timestamp (e.g. TS 102b), an update type (e.g. UT 102c), a data element (Data 102d) and an epoch number (E 102e). Embodiments of the present invention may be implemented using additional items or subsets of the items listed above. The creation and use of an IUD log in accordance with embodiments of the present invention is explained further with respect to FIG. 3.

FIG. 3 is a block diagram showing a system that may perform logging and conflict resolution in accordance with embodiments of the present invention. The diagram shown in FIG. 3 is generally referred to by the reference numeral 120. A system 122 is adapted to perform logging operations and conflict resolution in accordance with embodiments of the present invention. The system 122 may operate in conjunction with a database program and may comprise a portion of such a program.

In the normal course of operation, a base or underlying table 128 may be updated when users perform IUD operations, as illustrated in FIG. 3. A materialized view 130 is based, at least in part, on the underlying table 128. Accordingly, changes to the underlying table 128 may have an impact on the materialized view 130. A logging mechanism 124 receives IUD information as the underlying table 128 is changed. The logging mechanism 124 employs the IUD information to create an IUD update log 100, as described in FIG. 2. A refresh manager 126 may be employed to periodically refresh the materialized view 130 based on the changes to the underlying table 128.

The refresh manager may obtain information from the update log 100, as shown in FIG. 3. Those of ordinary skill in the art will appreciate that the refresh manager 126 may also receive information from the underlying table itself. For example, information from the underlying table 128 may be required by the refresh manager 126 in the case of an entry corresponding to a range in the update log 100. A range entry would not typically include the actual data stored to the underlying table 128, so that data would need to be obtained from the underlying table 128 itself. When performing refresh operations on the materialized view 130, the refresh manager 126 may resolve conflicts introduced by range logging, as fully explained below.

For purposes of explaining logging operations in accordance with embodiments of the present invention, consider an exact set of all the log records that are relevant to a materialized view for a given table, T. A given invocation of a refresh operation may be referred to as the table delta or T-delta. The logging to the IUD log may be done automatically as a part of the lnsert/Update/Delete operations. Two types of logging may be supported, which may result in two types of records in the IUD log. The first type of record relates to IUD logging operations on single rows where each row in the base table is identified by a primary key value. The second type of record relates to the logging of new ranges in the primary key that result from bulk inserts. A new range is a range in the primary key that was empty of data before the massive insert happened. The new range is locked during the insert.

Range logging may be introduced to the system to optimize the logging time and space requirements. To reproduce the logging information from a range in the IUD log, the range and the table may be joined.

To obtain a better availability, deferred refresh operations may be broken into multiple transactions. This new refresh approach may be referred to as a multi-transaction refresh. A materialized view that is refreshed using a multi-transaction refresh may be referred to as a “highly available materialized view.” Because the refresh algorithm is broken into short fractions, each executed in a different transaction, each fraction of the original refresh is lighter and faster and therefore the materialized view rows that are updated by each refresh transaction will be released shortly and will be available for querying. Even though the breaking of the refresh into smaller fractions might cause some performance deterioration, the availability of highly available materialized view may be improved with respect to other materialized views.

Because the refresh process is broken into multiple transactions, the atomicity of the refresh operation is not guaranteed by the transactional system. Accordingly, both the multi-transaction refresh algorithm and the multi-transaction refresh recovery algorithm may be addressed in embodiments of the present invention.

In embodiments of the present invention, two solutions of highly available materialized views may be employed. One of these solutions is applicable only for single-delta materialized views. A single-delta materialized view is a materialized view that can be refreshed based on changes (delta) of a single table. For example, a single delta materialized view is a SUM aggregate on a single table. A single-delta materialized view must satisfy the following requirement: the materialized view is based either on a single table, or on a join where only one of the tables should observe its delta (e.g. the other tables are insert only lookup tables in which a foreign key is defined on the join predicate). A foreign key is an attribute or collection of attributes that corresponds to or refers to a primary key in another table of the database.

Every time a deferred materialized view is refreshed, a new epoch may be set for all its underlying base tables. As set forth above, the epoch value is an attribute of the base table (T.CURRENT_EPOCH). At the beginning of a refresh operation, each base table is locked, the epoch (T.CURRENT_EPOCH) is set and then the lock is released. The lock during the epoch setting guarantees that values from the same transaction will belong to the same epoch. The use of epochs may be implemented in multiple ways. For example, the epoch may be the timestamp taken during the table lock period in the beginning of the refresh or it can be any other ever-increasing number. All the underlying base table log records that have appeared between two consecutive invocations of a refresh of the materialized views on that base table have the same epoch.

Every deferred materialized view maintains a vector of current epochs in the metadata area, one value per each base table. For a materialized view MV on a base table T, the value MV.EPOCH [T] stands for the first epoch that was not applied to MV in T-log (i.e., the next time this materialized view will be refreshed, the T-delta computation for it should involve only those log records in T-log that have MV.EPOCH[T]<=Log_Record.EPOCH<T.CURRENT_EPOCH).

T.CURRENT_EPOCH is incremented if some deferred materialized view on T must be refreshed. The increment happens before the refresh for that materialized view starts. The MV.EPOCH[T] is updated upon a successful refresh of MV:MV.EPOCH[T]←T.CURRENT_EPOCH. A refresh algorithm is activated in each transaction in a normal refresh process and in the refresh recovery process. The invocation of the refresh algorithm may be referred to as the refresh-command. The refresh-command is responsible for applying part of the delta to the materialized view. Also, the mechanism that executes the refresh-command and handles the transactions may be referred to as the refresh-procedure. The refresh-procedure is also responsible for the refresh-recovery algorithm.

Before the refresh-procedure invokes the refresh-command, the conflicts between a set of log records that refer to the same table row (i.e., have the same table primary key value) must be resolved. As set forth below, there are two types of logging conflicts that must be resolved.

The first type of logging conflict occurs between range records. Ranges may overlap totally or partially. This conflict can happen, for example, if a user performs a bulk insert that is range-logged, deletes a part of inserted data, and performs a new bulk insert (that is also range-logged) in an overlapping area (in place of deleted data). Resolving conflicts between ranges is vital for correctness, to avoid multiple contributions to materialized views. This is an interval intersection analysis problem.

The second type of logging conflict occurs between the single-row records and the range records (also called cross-type duplicates). This conflict can happen when a part of data that is inserted in a bulk (and range-logged) is updated before the next invocation of refresh. Single-row records store copies of affected rows, whereas range records keep pointers into the table. Therefore, if a single-row record is logically “covered” by a range, it should not be applied, because the correct “version” of the data will be reproduced by a join between the range and the table. A double application (of the single-row record and the range) would result in duplicate contribution to materialized views. Therefore, the result would be incorrect.

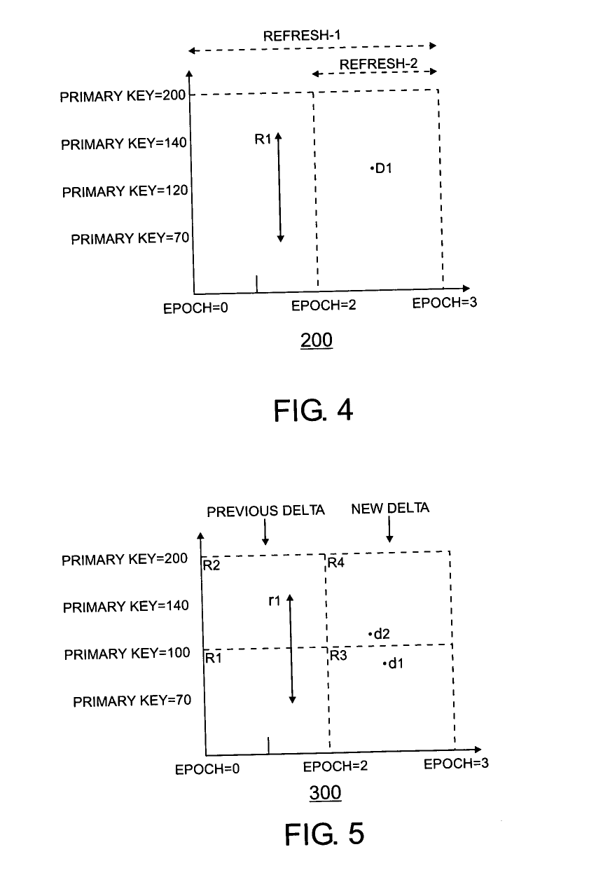

The refresh-procedure may solve these conflicts by running a duplicate elimination algorithm. Because a single table can be a delta of multiple materialized views, the duplicate elimination algorithm is designed to serve multiple refresh operations where each refresh operation can monitor the log from a different epoch value to T.CURRENT_EPOCH. An illustration that helps to explain conflict resolution is now discussed with reference to FIG. 4.

FIG. 4 is a schematic diagram showing illustrating conflicts between a single-row and a range in a database environment. The diagram is generally referred to by the reference numeral 200. In the example shown in FIG. 4, the duplicate elimination algorithm needs to serve two refresh operations. The refresh of the less updated materialized view, denoted as refresh-1, monitors the log from epoch 0 to epoch 3 and the second refresh, denoted as refresh-2, monitors the log from epoch 2 to epoch 3. Notice that refresh-1 must ignore the delete operation D1. Since the table row with primary key 120 was deleted, retrieving the range R1 from the table while applying the delta does not retrieve that row. This hole in the range is due to the delete operation that is logged as D1. Now, if the refresh algorithm applies the D1 record, it is as if the delete operation is applied twice. On the other hand, refresh-2 must not ignore the delete operation D1. The range operation R1 was applied to the materialized view before the delete happened (in a previous invocation of the refresh) thus, when R1 was retrieved from the table, the table row with primary key 120 was applied to the materialized view and now it must be deleted.

In order to solve this problem, the duplicate elimination algorithm marks the single-row log-records with a special ignore mark. Using this mark, each refresh operation with a defined delta can filter conflicting operations in that delta.

Also notice that the duplicate elimination algorithm only updates the table log (ignore mark) in previous epochs. Therefore it does not affect the availability of the table nor does it affect the availability of the materialized view. The refresh-procedure can use the same duplicate elimination algorithm for regular materialized views and for highly available materialized views.

Next, multiple-transaction refreshes for highly available materialized views will be discussed. For highly available materialized views, the refresh process is broken into short transactions. In each transaction, a different portion of the updates contained in the IUD log is applied to the materialized view. Thus, every transaction locks the materialized view only for a short duration and, in most cases, only a small fraction of the materialized view rows are locked. The intermediate state of the materialized view during the refresh process might not reflect the database state at any moment of time. However, the materialized view rows that do not need to be updated for the current delta are consistent with the table data and also available for the user. Two solutions for highly available materialized views may be applicable.

The first solution, which may be referred to hereinafter as solution-1, is applicable to materialized views with a single delta. Such a materialized view is refreshed in multiple steps. The refresh reads N rows from the log ordered by the table primary key and then starts to look for a primary key value boundary. After a primary key value boundary is detected, these rows are applied to the materialized view and the transaction is committed.

The second solution, which is hereinafter referred to as solution-2, is applicable to materialized views that are refreshed in two phases. In phase 1, the table delta is computed in non-audit mode (to avoid transaction timeout) and the result, the table delta, is written to a log. When a table is in a non-audit mode, changes to table data are not written into the database audit log. Because the database relies on the audit log to provide transaction properties such as atomicity, concurrency, independency, durability (“the ACID properties”) and the like, the changes made to a non-audit table cannot be done inside transactions. To guarantee correctness of audited tables, databases typically enforce a rule that requires changes to audited tables to be done inside transactions. Therefore anon-audited table may be used to avoid overhead and transactional limitations at the expense of the ACID properties. In case of a failure during an IUD statement to the table, the application and not the database is responsible for the correct recovery of the data in the non-audited table. In phase 2, the materialized view is updated. The table delta (from the refresh or IUD log) is applied to the materialized view in multiple transactions.

The advantage of solution-1 is that the materialized view delta is not written to the disk. However each materialized view row might be updated more then once. A major benefit of solution-2 is that each materialized view row is updated no more than once per refresh. Design goals and predetermined performance criteria for a given database environment may dictate a selection of solution-1 or solution-2.

In order to allow recovery, the refresh-command must be able to distinguish between log records that were already applied to the materialized view in previous transactions (i.e., applied delta) and log records that still need to be applied to the materialized view (i.e., unapplied delta). This is done by applying the log records in the primary key order.

In solution-1, the underlying table is in primary key order. In solution-2, the materialized view is in primary key order. Thus, the last primary key value can separate between the applied delta and the unapplied delta. Notice that for solution-1 the delta can contain more than a single log record for a given table key value. Thus, in order to allow the separation by the table primary key, the refresh-command stops applying log records only when a log record for a different table primary key value appears. The last event is called a primary key value boundary.

Because the refresh process is broken into multiple transactions, the atomicity of the refresh operation is not guaranteed by the transactional system. The recovery algorithm of solution-2 is simple. The last applied primary key value should be recorded as part of the transaction. In case of failure the transaction is rolled back with the last primary key value and the refresh should continue from the first primary key valued that is greater than the recorded primary key value.

Hereinafter, the unique recovery algorithm of highly available materialized views refers to solution-1. When highly available materialized views are referred to hereinafter, such highly available materialized views may be assumed to be refreshed according to solution-1.

The following discussion refers to the normal process of the refresh-command. The refresh-command reads N rows (i.e., N is a pre-defined constant) from the log ordered by the table primary key and then starts to look for a primary key value boundary. After a primary key value boundary is detected, these rows are applied to the materialized view and the transaction is committed. In general, the refresh-command of highly available materialized views has the ability to apply a delta that is defined by a beginning point and an ending point. The beginning point may be a pair that comprises the beginning epoch and the starting primary key values. The ending point may be a pair that comprises the end epoch and the ending primary key values.

The following discussion relates to multiple-transaction refresh recovery for highly available materialized views. As set forth above, this recovery algorithm is applicable for the highly available materialized views that are described in solution-1.

The recovery algorithm for the refresh of highly available materialized views deals with failures that happen during the course of a refresh for a given materialized view. Failures can happen at any point of the refresh process, however since the refresh of highly available materialized view is done under multiple transactions as explained above, the recovery algorithm can consider only failures that happened at transactions boundaries. If a failure occurs in the middle of a refresh transaction, the transactional system is responsible for undoing the changes of the current transaction.

Because failures can also happen in the middle of the refresh recovery, the refresh recovery process must be able to recover itself and to complete the recovery of the refresh. This type of failure model may be referred to as a nested failures model.

The refresh recovery algorithm under a nested failures model must deal with the following problem. When the table has a range log, the refresh accesses both the table and the table delta. In such cases, a lock on the table is taken on behalf of the refresh in order to insure the consistency of the table and the delta. However, if a failure occurs in the middle of such a refresh, the lock on the table is dropped and table might be out of sync with the previous delta (defined by the previous epoch numbers). The only available synchronized pair of table and delta is the pair of the current delta and the current table state (it is impossible to access a previous version of the table). Thus, the recovery algorithm must refresh the materialized view to the time of the beginning of the recovery and not to the time of the previous refresh/refresh-recovery.

Despite the above, refreshing the materialized view to the time of the recovery does not solve the whole problem, since the new delta may contain conflicts with the ranges of the previous delta. FIG. 5 describes the log after a failure of a refresh operation.

FIG. 5 is a schematic diagram showing the effects of conflicts between deltas in a database refresh operation in accordance with embodiments of the present invention. The diagram is generally referred to by the reference numeral 300.

In this example, the refresh algorithm has failed in epoch 2 after applying to the materialized view the entire delta below the primary key 100. Before the invocation of the recovery process, the table was updated and two rows were deleted, one row with primary key 80 (d1) and the other with primary key 120 (d2). The whole delta contains updates to table rows with primary keys between 0 and 200. Notice that the R1 rectangle includes the log records that were already applied to the materialized view and the other three rectangles consist of log records that need to be applied. As in the normal refresh operation, when the refresh-procedure is invoked again (after the failure), the duplicate elimination algorithm is first performed on the entire delta.

The trivial approach for refresh recovery is to continue the last refresh algorithm between epoch 0 and 2 from primary key 100 (R2) and then to refresh the materialized view from epoch 2 to 3 and apply the new delta (R3 U R4). However, this solution is incorrect due to the conflicts between the range log records in R1, R2 and the records in R3, R4. In the current example, in the second refresh operation that applied (R3 U R4), the delete operation d2, as well as d1, will not be ignored. However, unlike the normal refresh operation, when we applied the part of the range of r1 which resides in R2, the delete operation d2 was already done. Thus the table row that was deleted by d2 was not retrieved and d2 should be ignored.

In light of this the following approach may be chosen. When the refresh-procedure is invoked after a failure, it invokes the duplicate elimination algorithm on the entire delta. The refresh algorithm is then invoked twice. First, the refresh algorithm is performed on the log records in the R3 rectangle. The second time the refresh algorithm is performed, the log records in the (R2 U R4) rectangles are applied.

The logic behind this algorithm is to break the materialized view (and the accompanying refresh operation) into two components. The first part of the materialized view consists of table records below the last applied primary key (primary key 100 in the example shown in FIG. 5) and the other part consists of table records above that key. Now we can consider these two parts as two different materialized views where one of the materialized views is more updated than the other. The refresh algorithm is invoked twice each time on a different part of the materialized view. As in a normal refresh operation, each refresh algorithm invocation resolves correctly the conflicts by using the duplicate elimination algorithm ignore marks. The refresh-recovering algorithm becomes more complex when multiple failures occur however the previous approach can be extended to support nested failures as well.

Next, the applicability of refresh-procedure refreshes to a highly available materialized view is discussed. The recovery algorithm supports the nested-failures model and ensures that if the number of failures is within system limits, the materialized view will be eventually refreshed, and will reflect the state of the used table at the beginning of the last invocation of refresh-procedure.

Every multi-transactional materialized view maintains a context table that serves it during the multi-transactional refresh. This table is created automatically upon the execution of a CREATE MV operation. The table holds the (epoch, T-PKey columns), where T-PKey stands for the primary key columns of the table. Every invocation of the refresh-command (always done in a separate transaction), except the last one, inserts a context row into the context table. Before inserting the new context, the refresh-command deletes the previous context row (in every invocation except the first one). The context is the greatest primary key value applied by refresh-statement it is also the lower bound for the next invocation.

If the refresh-procedure performs a part of its transactions and fails, this is a recovery case. In the next invocation of the refresh-utility, the refresh process must be continued from the same point, in an incremental and multi-transactional way.

Recovering a highly available materialized view from failure is a nontrivial problem because between the original application of refresh and the recovery, changes may happen to the primary key area that has already been applied. These changes must be re-integrated into the materialized view, in a process called catch-up. During catch-up, the refresh-command applies the log rows from the new epochs (i.e., the epochs unobserved by the previous invocation), up to the primary key value reached previously. In this setting, the previous context is used as an upper bound. Once the catch-up is complete, the least common denominator is reached for the log data in the “new” and “old” epochs. After catch-up is complete, the execution can continue in its normal mode, in the whole range of epochs.

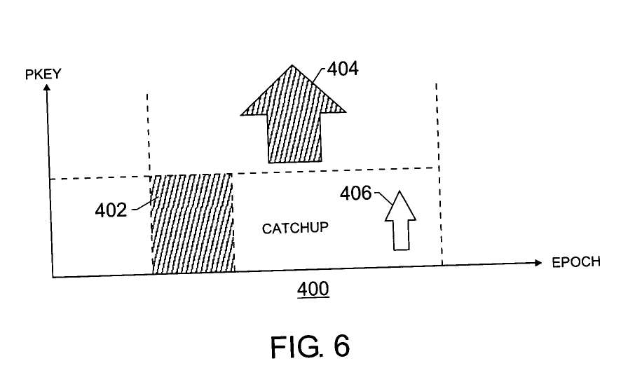

FIG. 6 is a schematic diagram illustrating the concept of catch-up in a database environment in accordance with embodiments of the present invention. The diagram is generally referred to by the reference numeral 400. In the example shown in FIG. 6, the range of primary key values that have been applied in the previous invocation is identified by the reference numeral 402. The arrow 404 depicts the normal continuation phase and the arrow 406 depicts the catch-up phase. Dashed lines depict the epoch and primary key boundaries, respectively.

The catch-up stage (as well as the normal continuation phase) is multi-transactional. Therefore, at this stage, the invoked refresh-command(s) will write the new context. This context has been used as a lower bound in the catch-up process, whereas the old context is an upper bound. Hence, the data applied is between two known points or “watermarks.”

From the point of view of a refresh-statement, the first invocation differs from the following invocations because it does not delete a context row. The first invocation is marked as phase 0 while all the following invocations are marked as phase 1. Overall, there are four modes of invocation (regarding the context rows to be considered), which are set forth in Table 1:

TABLE 1

| | NO CATCHUP | CATCHUP |
|---|---|---|
| | (no recovery) | (recovery) |
| PHASE 0 | No bounds | Upper bound |
| PHASE 1 | Lower bound | Lower + upper |
| | | bounds |

Because the catch-up process is also multi-transactional, it is also subject to failures. Therefore, the next time the refresh-procedure is invoked, it will start from recovering the failed catch-up, prior to resuming the normal recovery process. In general, the refresh-procedure can start running with a stack of nested failures. A separate context row corresponds to the maximum primary key value applied at each invocation (which did not complete the job). Next, a nested catch-up scenario is considered.

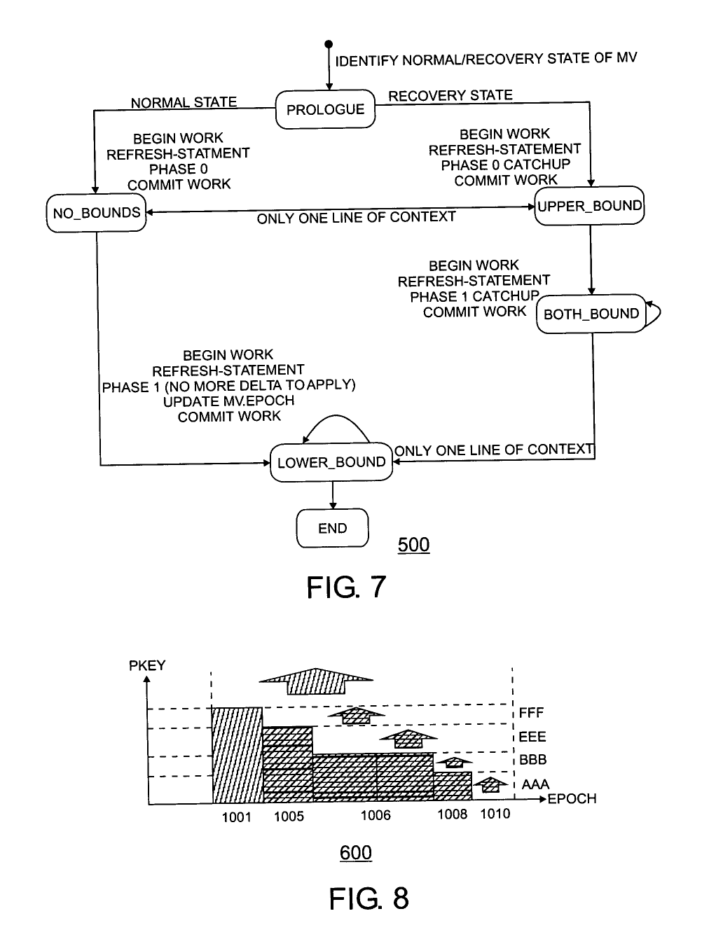

FIG. 7 is a finite state diagram of a highly available materialized view in accordance with embodiments of the present invention. The state diagram is generally referred to by the reference numeral 500. The state diagram formalizes the algorithm of solution-1. There are four states that correspond to the four modes of invocation described above in Table 1. There are also two additional states that describe the start state (prologue) of the algorithm and the end state (epilogue) of the algorithm. The text written above the arcs describes the conditions under which this path is taken. All invocations of the refresh statements are done inside transactions (begin work, commit work) to guarantee atomicity.

FIG. 8 is a schematic diagram that illustrates a nested catch-up scenario in accordance with embodiments of the present invention. The diagram is generally referred by reference numeral 600. In the example shown in FIG. 8, one normal invocation and four catch-ups have failed without completing the job. Suppose the last invocation goes on without failures. The actions it performs are as follows:
1. Recover (catch-up) the 4th (failed) catch-up-epochs 1011-1011.
2. Complete the 4th catch-up (i.e., recover the 3rd catch-up)-epochs 1010-1011.
3. Complete the 2nd and 3rd catch-ups-epochs 1006-1011.
4. Complete the 1st catch-up epochs 1005-1011.
5. Complete the normal execution-epochs 1001-1011.

Note that at each recovery stage, the upper bound of the previous stage becomes the current lower bound. Note also that the second and third catch-ups can be completed together, because the third one has crashed exactly after equating the “watermark” with the second one. Hence, from the point of view of the recovery, they are like a single stage that worked on the epoch interval 1006-1009.

Thus, embodiments of the present invention contemplate a refresh policy that ensures that a highly available materialized view will remain available during refresh and that the refresh transaction time will be limited. These factors allow continued use of the database, with the highly available materialized view being refreshed on an on-going basis. Thus, embodiments of the present invention may provide highly available materialized views that manifest improved latency with respect to other materialized views.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A system that allows a table and a materialized view to be available while the materialized view is being refreshed, the system comprising:
a materialized view that is derived at least in part from a table;
a refresh log that contains a plurality of entries, each of the plurality of entries corresponding to a change in the table, each of the plurality of entries comprising an epoch identifier; and
a refresh manager that performs a refresh operation on the materialized view in multiple steps by (a) successively reading a first subset of the plurality of entries indicated by a specific epoch identifier from the refresh log, (b) identifying a second subset of the plurality of entries from within the first subset of the plurality of entries, the second subset of the plurality of entries falling within a primary key value boundary and (c) applying the second subset of the plurality of entries to the materialized view.

2. The system set forth in claim 1, wherein the corresponding epoch identifiers represent epoch numbers that have been created since a previous refresh operation on the materialized view.

3. The system set forth in claim 1, wherein the second subset of the plurality of entries is applied to the materialized view in a primary key order.

4. The system set forth in claim 1, wherein the refresh manager is adapted to distinguish between entries of the second subset of the plurality of entries that have already been applied to the materialized view in previous transactions and entries of the second subset of the plurality of entries that have not been applied to the materialized view in the event of a failure of the refresh operation.

5. A method of refreshing a materialized view that is in part derived from a table, the method being adapted to improve the availability of the table and the materialized view while the materialized view is being refreshed, the method comprising:
deriving a materialized view from at least one table;
assigning an epoch identifier to changes made to the at least one table;
storing an entry corresponding to each change to the at least one table in a refresh log that includes a plurality of entries, each of the plurality of entries comprising an epoch identifier; and
performing a refresh operation in multiple operations, each of the multiple operations comprising (a) successively reading a first subset of the plurality of entries indicated by a specific epoch identifier from the refresh log, (b) identifying a second subset of the plurality of entries from within the first subset of the plurality of entries, the second subset of the plurality of entries falling within a primary key value boundary and (c) applying the second subset of the plurality of entries to the materialized view.

6. The method set forth in claim 5, comprising applying the second subset of the plurality of entries to the materialized view in a primary key order.

7. The method set forth in claim 5, comprising defining the epoch identifier to correspond to changes that have been made to the table since a previous refresh operation on the materialized view.

8. The method set forth in claim 5, comprising distinguishing between entries of the second subset of the plurality of entries that have already been applied to the materialized view in previous transactions and entries of the second subset of the plurality of entries that have not been applied to the materialized view in the event of a failure of the refresh operation.

9. A system that provides availability of a table and a materialized view while the materialized view is being refreshed, the table being derived at least in part from the materialized view, the system comprising:
a refresh log that contains a plurality of entries; and
a refresh manager that computes a table delta based on the refresh log and applies the table delta to the materialized view.

10. The system set forth in claim 9, wherein each of the plurality of entries comprises an epoch identifier.

11. The system set forth in claim 10, wherein the epoch identifier corresponds to changes that have been made to the table since a previous refresh operation on the materialized view.

12. The system set forth in claim 9, wherein the table delta is applied to the materialized view in a primary key order.

13. The system set forth in claim 9, wherein the table delta is used to refresh the materialized view in multiple transactions.

14. The system set forth in claim 9, wherein a primary key value for each entry from the refresh log is recorded after that entry is applied to the materialized view.

15. The system for refreshing the materialized view set forth in claim 9, wherein the refresh manager is adapted to distinguish between a first subset of the plurality of entries that have already been applied to the materialized view in previous transactions and a second subset of the plurality of entries that have not been applied to the materialized view in the event of a failure of the refresh operation.

16. A method of refreshing a materialized view that is derived at least in part from a table, the method being adapted to provide availability of the table and the materialized view while the materialized view is being refreshed, the method comprising the acts of:
storing a plurality of entries corresponding to changes in the table in a refresh log;
computing a table delta based on the refresh log;
refreshing the materialized view based on the table delta.

17. The method set forth in claim 16, wherein the table delta is applied to the materialized view in a primary key order.

18. The method set forth in claim 16, comprising updating the materialized view in multiple transactions.

19. The method set forth in claim 16, comprising storing an epoch identifier as a portion of each of the plurality of entries.

20. The method set forth in claim 19, comprising defining the epoch identifier to correspond to changes that have been made to the table since a previous refresh operation on the materialized view.

21. The method set forth in claim 16, comprising recording the primary key value for each entry from the update log after that entry is applied to the materialized view.

22. The method set forth in claim 16, comprising distinguishing between a first subset of the plurality of entries that have already been applied to the materialized view in previous transactions and a second subset of the plurality of entries that have not been applied to the materialized view in the event of a failure of the act of refreshing the materialized view.

23. A system that provides availability of a table and a materialized view while the materialized view is being refreshed, the table being derived at least in part from the materialized view, the system comprising:
a refresh log that contains a plurality of entries; and
means for computing a table delta based on the refresh log; and
means for applying the contents of the table delta to the materialized view.

24. The system set forth in claim 23, wherein each of the plurality of entries comprises an epoch identifier.

25. The system set forth in claim 24, wherein the epoch identifier corresponds to changes that have been made to the table since a previous refresh operation on the materialized view.

26. The system set forth in claim 23, wherein the means for applying the table delta to the materialized view is adapted to distinguish between a first subset of the plurality of entries that have already been applied to the materialized view in previous transactions and a second subset of the plurality of entries that have not been applied to the materialized view in the event of a failure of applying the table delta to the materialized view.

27. A computer program, comprising:
a machine readable medium;
a refresh log stored on the machine readable medium, the refresh log containing a plurality of entries; and
a refresh manager stored on the machine readable medium, the refresh manager being adapted to refresh a materialized view that is derived at least in part from a table by computing a table delta based on the refresh log and applying the table delta to the materialized view.

28. The computer program set forth in claim 27, wherein each of the plurality of entries comprises an epoch identifier.

29. The computer program set forth in claim 28, wherein the epoch identifier corresponds to changes that have been made to the table since a previous refresh operation on the materialized view.

30. The computer program set forth in claim 27, wherein the refresh manager is adapted to distinguish between a first subset of the plurality of entries that have already been applied to the materialized view in previous transactions and a second subset of the plurality of entries that have not been applied to the materialized view in the event of a failure of a refresh operation.
